(19) United States
(12) Patent Application Publication
(10) Pub. No.: US 2026/0094495 A1
(43) Pub. Date: Apr. 2, 2026

(54) UNIVERSAL PROGRESSIVE GATEWAY SYSTEMS AND METHODS IN ELECTRONIC GAMING

(71) Applicant: Aristocrat Technologies, Inc., Las Vegas, NV (US)

(72) Inventors: James Urbaniak, Fairview, TN (US); Kelton Flinn, Charlottesville, VA (US); Jennifer Pinder, Spring Hill, TN (US); Kimberly Otts, Murfreesboro, TN (US); Kent Reisdorph, Columbia, TN (US); Jatin Khurana, New Delhi (IN)

(21) Appl. No.: 18/902,903

(22) Filed: Sep. 30, 2024

(51) Int. Cl. G07F 17/32

(52) U.S. Cl. CPC G07F 17/3225

(57) ABSTRACT

An electronic gaming system including a memory and a processor is described. The processor is configured to receive input data from an electronic gaming device of a plurality of electronic gaming devices wherein the input data includes an input amount associated with an electronic game and a device identifier (ID) associated with the electronic gaming device. The processor is also configured to determine a progressive associated with the electronic gaming device from a plurality of progressives wherein the progressive is associated with a progressive ID and determine a progressive controller associated with the progressive. The processor is further configured to transmit at least part of the input data to the progressive controller, receive an updated value for the progressive from the progressive controller, and broadcast a progressive update message to the plurality of electronic gaming devices.

### TECHNICAL FIELD

The field of disclosure relates generally to electronic gaming, and more specifically, to universal progressive gateway systems and methods in electronic gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system including at least one memory with instructions stored thereon and at least one processor in communication with the at least one memory is described. The instructions, when executed by the at least one processor, cause the at least one processor to receive input data from an electronic gaming device of a plurality of electronic gaming devices wherein the input data includes an input amount associated with an electronic game at the electronic gaming device and a device identifier (ID) associated with the electronic gaming device. The instructions also cause the at least one processor to, based on the device ID, determine a progressive associated with the electronic gaming device from a plurality of progressives wherein the progressive is associated with a progressive ID and, based on the progressive ID, determine a progressive controller associated with the progressive from a plurality of progressive controllers. The instructions further cause the at least one processor to transmit at least part of the input data to the progressive controller, receive an updated value for the progressive from the progressive controller, and broadcast a progressive update message to the plurality of electronic gaming devices wherein the progressive update message includes the updated value and the device ID and wherein the electronic gaming device is configured to update a value of the progressive at the electronic gaming device to the updated value based upon receiving the broadcast and identifying that the updated value is associated with the device ID.

In another aspect, at least one non-transitory computer-readable storage medium with instructions stored thereon is described. The instructions, in response to execution by at least one processor, cause the at least one processor to receive input data from an electronic gaming device of a plurality of electronic gaming devices wherein the input data includes an input amount associated with an electronic game at the electronic gaming device and a device identifier (ID) associated with the electronic gaming device and, based on the device ID, determine a progressive associated with the electronic gaming device from a plurality of progressives wherein the progressive is associated with a progressive ID. The instructions also cause the at least one processor to, based on the progressive ID, determine a progressive controller associated with the progressive from a plurality of progressive controllers and transmit at least part of the input data to the progressive controller. The instructions further cause the at least one processor to receive an updated value for the progressive from the progressive controller and broadcast a progressive update message to the plurality of electronic gaming devices wherein the progressive update message includes the updated value and the device ID and wherein the electronic gaming device is configured to update a value of the progressive at the electronic gaming device to the updated value based upon receiving the broadcast and identifying that the updated value is associated with the device ID.

In another aspect, a method for managing electronic communications in electronic gaming implemented by at least one processor in communication with at least one memory is described. The method includes receiving input data from an electronic gaming device of a plurality of electronic gaming devices wherein the input data includes an input amount associated with an electronic game at the electronic gaming device and a device identifier (ID) associated with the electronic gaming device and, based on the device ID, determining a progressive associated with the electronic gaming device from a plurality of progressives wherein the progressive is associated with a progressive ID. The method also includes, based on the progressive ID, determining a progressive controller associated with the progressive from a plurality of progressive controllers and transmitting at least part of the input data to the progressive controller. The method further includes receiving an updated value for the progressive from the progressive controller and broadcasting a progressive update message to the plurality of electronic gaming devices wherein the progressive update message includes the updated value and the device ID and wherein the electronic gaming device is configured to update a value of the progressive at the electronic gaming device to the updated value based upon receiving the broadcast and identifying that the updated value is associated with the device ID.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example computer system architecture including a universal progressive gateway, in accordance with the present disclosure.

FIG. 5 illustrates another example computer system architecture including a universal progressive gateway, in accordance with the present disclosure.

FIG. 6 illustrates an example class diagram for an example computer system including a universal progressive gateway, in accordance with the present disclosure.

FIG. 7 illustrates an example data flow diagram for registering a gaming device in an example computer system including a universal progressive gateway, in accordance with the present disclosure.

FIGS. 8A and 8B illustrate another example data flow diagram for registering a gaming device in an example computer system including a universal progressive gateway, in accordance with the present disclosure.

FIGS. 9A and 9B illustrate an example data flow diagram for claiming a progressive win in an example computer system including a universal progressive gateway, in accordance with the present disclosure.

FIGS. 10A and 10B illustrate an example data flow diagram for updating progressive meters in an example computer system including a universal progressive gateway, in accordance with the present disclosure.

FIG. 11 illustrates an example method for managing electronic communications in electronic gaming, in accordance with the present disclosure.

### DETAILED DESCRIPTION

Described herein are universal progressive gateway systems and methods in electronic gaming. In the example embodiment, gaming devices communicate with a universal progressive gateway (e.g., receiving progressive updates and making claims for a progressive). The devices do not know or care which progressives are local area progressives (LAPs) (e.g., single-site progressives (SSPs)) and which progressives are wide area progressives (WAPs) (e.g., multi-site progressives (MSPs)). Rather, here, for example, progressive contributions are routed as appropriate by the universal progressive gateway (e.g., if a gaming device is configured for LAP, the contribution is routed by the universal progressive to a LAP controller, if a gaming device is configured for WAP, the contribution is routed to a WAP controller, if a gaming device is configured for both LAP and WAP, the contribution is routed to both the LAP and WAP controllers).

As explained in further detail herein, the universal progressive gateway provides broadcasts regarding updated progressive amounts to gaming devices. Claims for a progressive (e.g., when won at a gaming device) are also managed by the universal progressive gateway.

Various technical problems exist in known progressive systems. For instance, known progressive systems require gaming devices to determine where (e.g., to which progressive controller) to send progressive messages (e.g., input amounts, claims for a progressive win, etc.) based on which progressives are available at the gaming devices. If a gaming device offers both a LAP and a WAP, two separate connections are required (e.g., to a LAP controller and a WAP controller) and the gaming device must determine which messages to send over which connection. Determining where to send messages associated with progressives and tracking which progressives are provided at gaming devices, by the gaming devices themselves, is computationally heavy and requires a burdensome amount software to be installed on gaming devices.

Accordingly, to solve at least the above technical problems, various technical solutions are provided herein. For instance, by providing a universal progressive gateway as described herein, computer resources at gaming devices are saved, computer efficiency at gaming devices is increased, and technical security benefits are provided. In the example embodiment, the gaming devices send progressive-related messages to the universal progressive gateway and the universal progressive gateway manages all needed determinations based on those messages (e.g., the gaming devices, regardless of games and/or progressives provided, send messages to the same universal progressive gateway). The gaming devices then monitor a broadcast from the universal progressive gateway for updates regarding progressives (e.g., all gaming devices can send messages to the same universal progressive gateway and receive the same broadcast from the universal progressive gateway).

As one example, implementing a universal progressive gateway as described herein allows for easier conversion of games between Class II and Class III. Gaming devices in communication with the universal progressive gateway do not need to determine which kind of games they are providing (e.g., Class II, Class III, Historical Horse Racing (HHR), etc.) and therefore which progressive controller(s) need to be updated based on gameplay at the gaming devices. Instead, the universal progressive gateway determines which progressive controller(s) need to be updated based on messages received from gaming devices (e.g., and registration of the gaming devices with the universal progressive gateway), and routes update messages to the appropriate progressive controller(s), as explained in further detail herein. In other words, a gaming device may simply send messages to and receive broadcasts from the same universal progressive gateway regardless of which type of game is being provided at the electronic gaming device.

Further, because all progressive messages are sent to the same universal progressive controller, various technical security benefits are provided (e.g., by the centralization and flexibility of the universal progressive controller, as well as removing the need for gaming devices to have separate connections to separate progressive controllers). Additional technical security benefits are provided based upon the various encoding and/or decoding (e.g., of level ID) techniques described herein (e.g., an interceptor receiving an encoded level ID would not be able to decode the encoded level ID without knowing a specific decoding technique implemented by the universal progressive gateway).

In the example embodiment, the universal progressive gateway provides a single point of contact for the gaming devices to obtain progressives (e.g., updated progressive amounts/meters, claims for progressive wins). A gaming device may be configured for LAP, WAP, or both, but the gaming device does not know or care where it gets progressive amounts from: it gets amounts and acts on them. The universal progressive gateway is responsible for combining multiple progressives from multiple sources into a single set of progressives for each gaming device to consume (e.g., the universal progressive gateway may provide a single broadcast with progressive amounts and gaming devices may identify which progressive amounts it needs to know based on an encoded level ID associated with the gaming device). The universal progressive gateway may not concern itself with the details of the various progressive implementations: WAP, LAP, a test, etc. For example, the universal progressive gateway may utilize the same protocol (e.g., gRPC protocol) to communicate with components associated with each progressive.

As an example, the universal progressive gateway may combine the separate reports from progressive proxies into a single merged report (e.g., including updated progressive amounts) for each gaming device (e.g., transmitted to each gaming device in a broadcast). When a gaming device reports a contribution, the contribution is directed to all concerned progressives, as appropriate, by the universal progressive gateway. When a gaming device claims a progressive, the claim is directed to the appropriate progressive by the universal progressive gateway.

In other words, the universal progressive gateway combines individual progressive broadcasts and rebroadcasts the combined broadcast as appropriate to each gaming device, routes progressive contributions as appropriate (e.g., if a gaming device is configured for both LAP and WAP, the contribution is routed to both the LAP controller and the WAP controller), and routes progressive claims to the appropriate progressive back end (e.g., the LAP controller or the WAP controller).

In the example embodiment, an electronic gaming system including at least one memory with instructions stored thereon and at least one processor in communication with the at least one memory is described. The instructions, when executed by the at least one processor, cause the at least one processor to receive input data from an electronic gaming device of a plurality of electronic gaming devices wherein the input data includes an input amount associated with an electronic game at the electronic gaming device and a device identifier (ID) associated with the electronic gaming device (e.g., an encoded level ID assigned to the gaming device by the universal progressive gateway during registration based on a progressive type (e.g., LAP, WAP) and denomination). The instructions also cause the at least one processor to, based on the device ID, determine a progressive associated with the electronic gaming device from a plurality of progressives wherein the progressive is associated with a progressive ID (e.g., and denomination) (e.g., the progressive ID may be an unencoded level ID that was utilized to generate the encoded level ID) and, based on the progressive ID (e.g., and denomination), determine a progressive controller associated with the progressive from a plurality of progressive controllers. The instructions further cause the at least one processor to transmit at least part of the input data to the progressive controller, receive an updated value for the progressive from the progressive controller, and broadcast a progressive update message to the plurality of electronic gaming devices wherein the progressive update message includes the updated value and the device ID and wherein the electronic gaming device is configured to update a value of the progressive at the electronic gaming device to the updated value based upon receiving the broadcast and identifying that the updated value is associated with the device ID.

In some embodiments, the plurality of progressives includes at least one local area progressive (LAP) and at least one wide area progressive (WAP).

In some embodiments, the device ID is an encoded ID (e.g., an encoded level ID associated with a progressive and a denomination) associated with the electronic gaming device. In some embodiments, the instructions further cause the at least one processor to determine the encoded ID based at least in part upon the progressive and transmit the encoded ID to the electronic gaming device. In some embodiments, the instructions further cause the at least one processor to determine and transmit the encoded ID as part of a registration process for the electronic gaming device with the electronic gaming system. In some embodiments, the instructions further cause the at least one processor to decode the encoded ID to at least one of determine the progressive or determine the progressive controller.

In some embodiments, the instructions further cause the at least one processor to receive a first progressive claim message associated with a claim for the progressive from the electronic gaming device and transmit a second progressive claim message based at least in part upon the first progressive claim message to the progressive controller, receive a first acknowledgement message associated with acknowledging the claim for the progressive from the progressive controller, and transmit a second acknowledgement message associated with the first acknowledgement message to the electronic gaming device. In some embodiments, the instructions further cause the at least one processor to, based at least in part upon the claim for the progressive, broadcast a second progressive update message including a reset value for the progressive and the device ID.

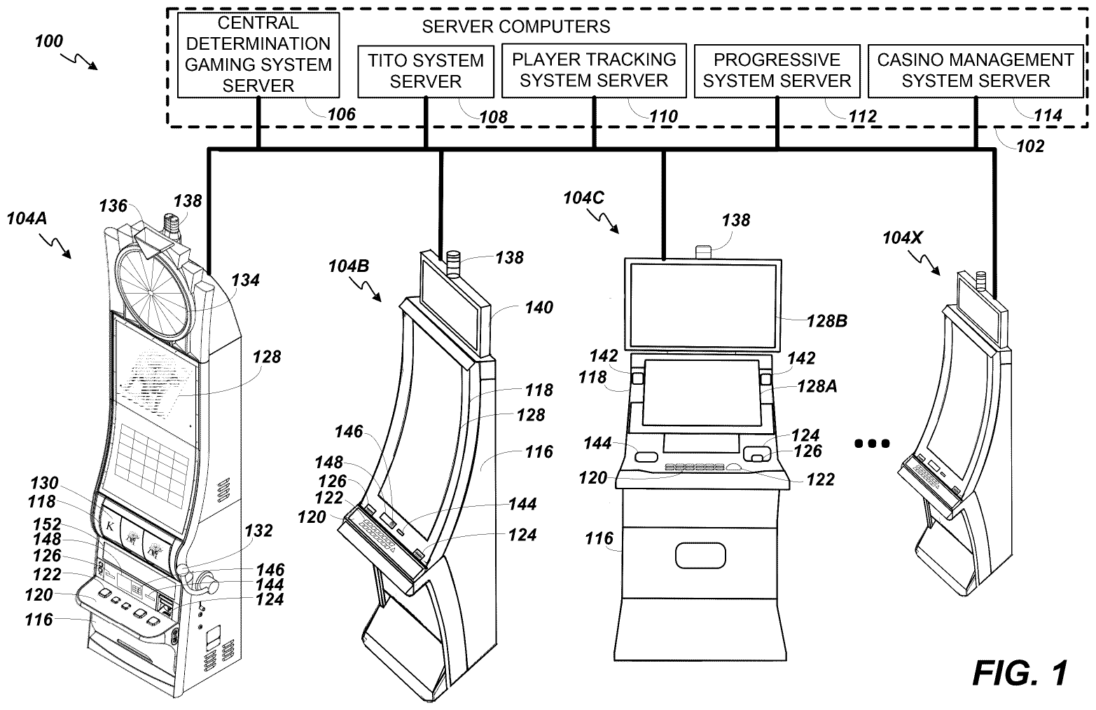

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

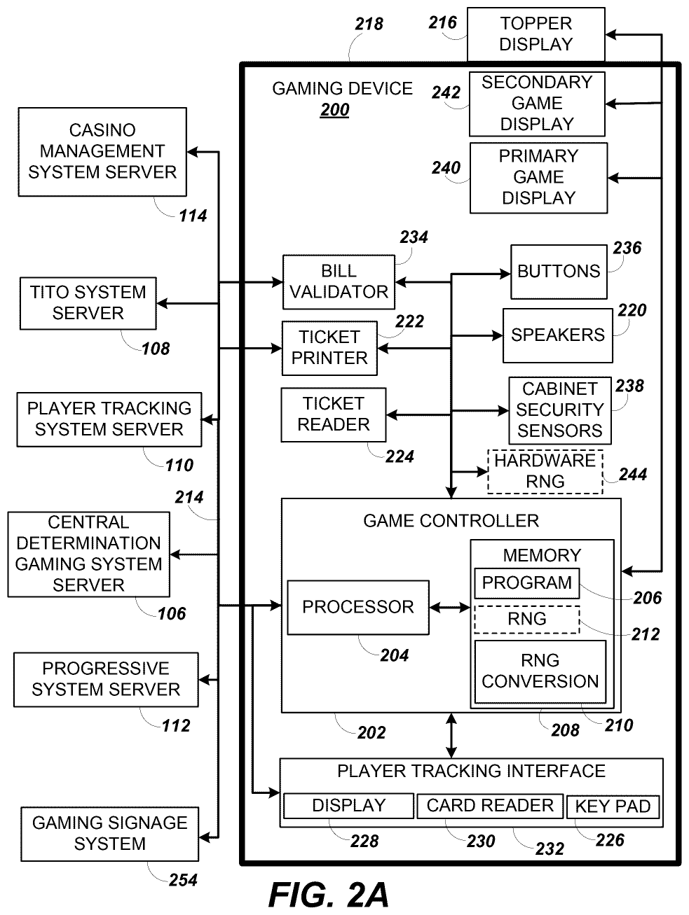

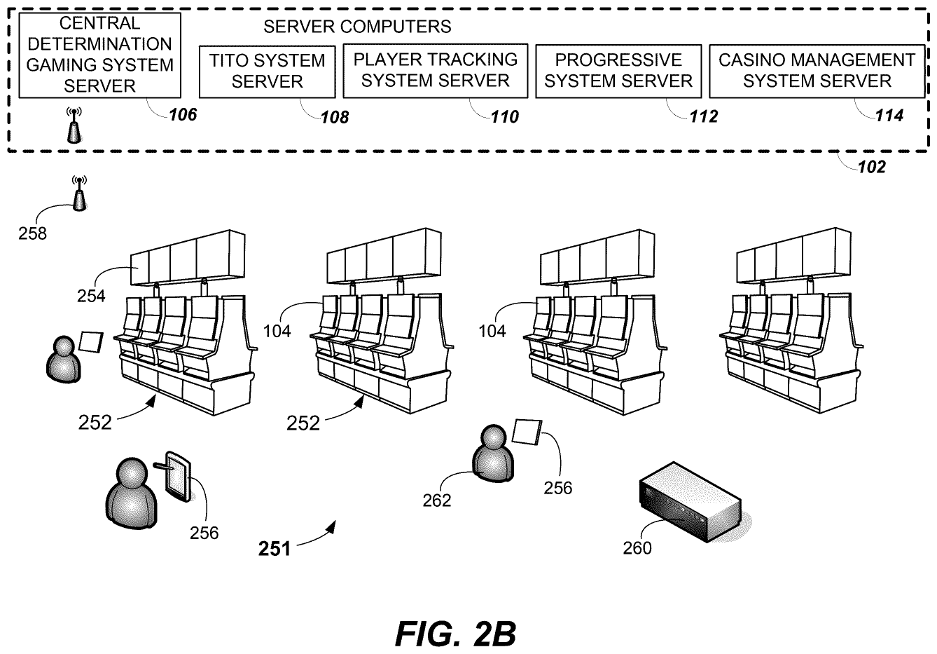

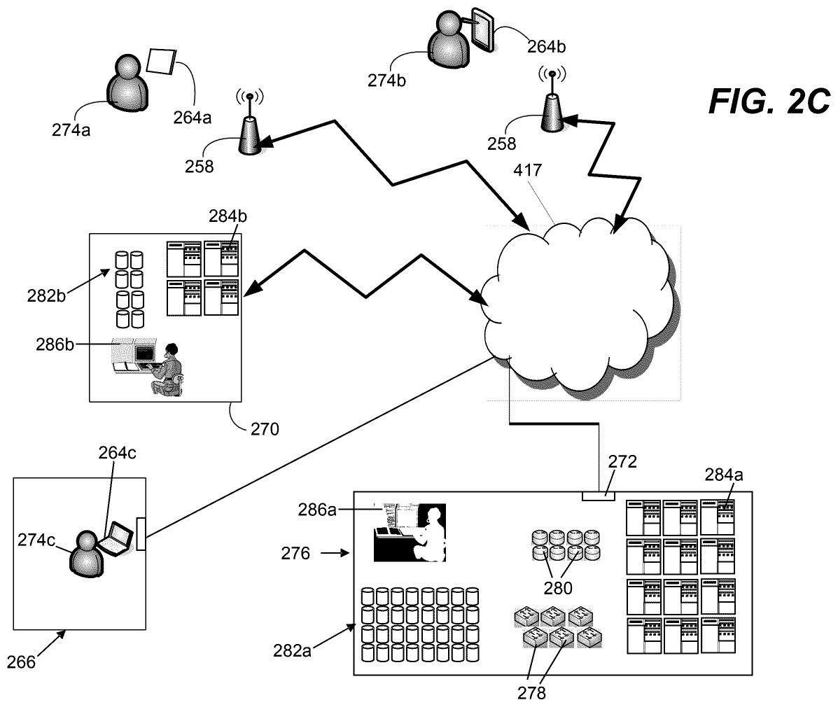

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps”and downloadable by authorized users.

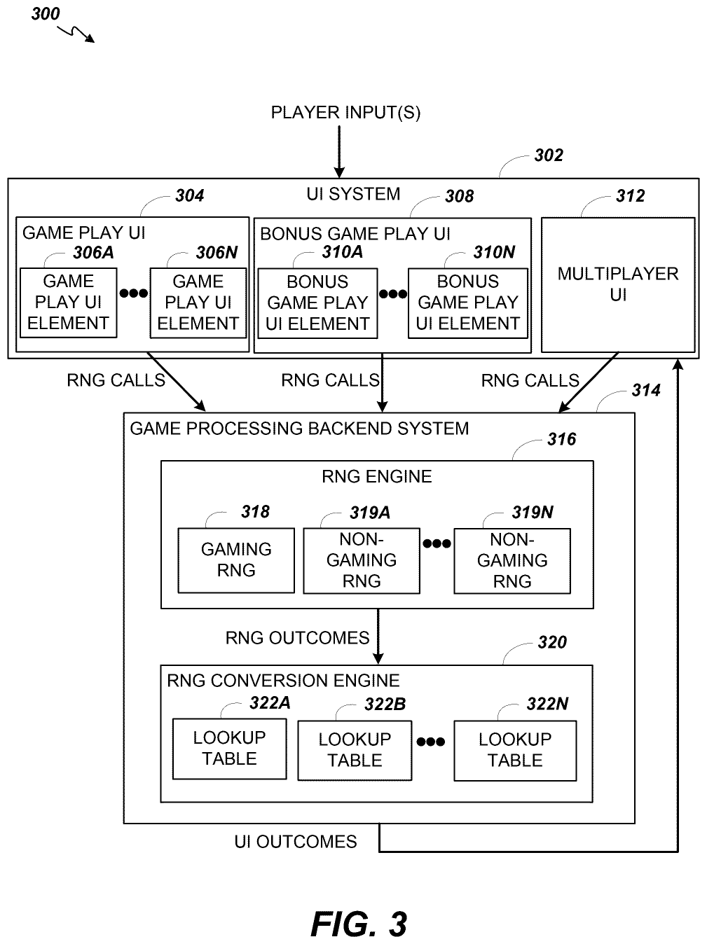

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI

### Elements 310a-310n.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

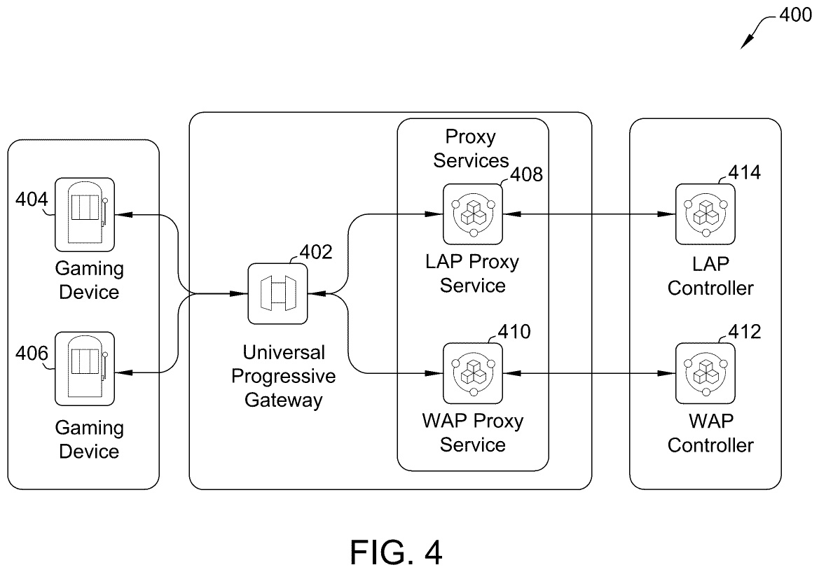

FIG. 4 illustrates an example computer system 400 architecture including a universal progressive gateway 402, in accordance with the present disclosure.

As shown in FIG. 4, gaming devices 404 and 406 (e.g., gaming devices 104A-X) are provided that are in communication with universal progressive gateway 402. Universal progressive gateway 402 serves as the primary interface for the gaming devices 404, 406 to transmit and receive progressive-related data. Universal progressive gateway 402 is also responsible for routing network traffic to an appropriate proxy service (e.g., LAP proxy service 408 and/or WAP proxy service 410) based on a progressive type or types identified based on which gaming device which data is received from (e.g., based on an encoded level ID (e.g., device ID) assigned to a gaming device and received from the gaming device in future communications).

In the example embodiment, LAP proxy service 408 handles network traffic for LAPs and WAP proxy service 410 handles network traffic for WAPs. Universal progressive gateway 402 is in communication with both LAP proxy service 408 and WAP proxy service 410.

Also shown in FIG. 4 as being in communication respectively with LAP proxy service 408 and WAP proxy service 410 are a WAP controller 412 (e.g., multi-site) and a LAP controller 414 (e.g., local, such as within a casino). In the example embodiment, WAP controller 412 and LAP controller 414 may be progressive servers (e.g., progressive system server 112).

In the example embodiment, universal progressive gateway 402 routes communications from gaming devices 404, 406 to WAP controller 412 and/or LAP controller 414. For instance, universal progressive gateway 402 may utilize a level ID, a multiplier, and an appended value depending on the progressive type (e.g., WAP or LAP). In other words, different progressives may have a different level ID assigned thereto and stored in memory (e.g., at WAP controller 412 and/or LAP controller 414). Universal progressive gateway 402 may utilize the level ID to generate an encoded level ID (e.g., by applying a multiplier to the level ID and adding an appended value assigned to the LAP or the WAP, depending on which of the LAP or the WAP the level ID is associated with).

During device registration, universal progressive gateway 402 generates at least one encoded level ID and transmits the encoded level ID to the gaming device being registered. The gaming device may not be made aware of the level ID, just the encoded level ID. Then, when transmitting future messages to universal progressive gateway 402 (e.g., meter update messages, claims for a progressive win, etc.) the gaming device may include the encoded level ID in the messages. Universal progressive gateway 402 would then decode the encoded level ID (e.g., divide by the multiplier, etc.) to determine which of WAP controller 412 or LAP controller 414 (e.g., or components associated therewith) to route associated communications to (e.g., using the decoded level ID or, in other words, the original level ID that the WAP controller 412 or the LAP controller 414 will know upon receipt).

As an example, during device registration, universal progressive gateway 402 may receive a serial number from a gaming device and utilize that serial number (e.g., and other information such as denomination) to identify a progressive type associated with the gaming device (e.g., based on data stored in memory) and, based on the progressive type, which of WAP controller 412 and/or LAP controller 414 to retrieve one or more level IDs from. Universal progressive gateway 402 then retrieves the one or more level IDs from WAP controller 412 and/or LAP controller 414 (e.g., stored at WAP controller 412 and/or LAP controller 414 and associated with they progressive type identified based on the serial number and/or denomination). Based on the one or more level IDs, universal progressive gateway 402 generates one or more encoded level IDs (e.g., based on the process described herein) and transmits the one or more encoded level IDs to the gaming device. Then, after registration, the gaming device may include at least one of the one or more encoded level IDs (e.g., sometimes referred to herein as a link ID or device ID) in communications with universal progressive gateway 402, which decodes received encoded level IDs to route communications accordingly (e.g., to WAP controller 412, LAP controller 414, and/or components associated therewith).

As another example, when broadcasting updated progressive levels (e.g., so that gaming devices can display accurate balances of progressives being offered), universal progressive gateway 402 may broadcast each updated balance as being associated with an encoded level ID. The gaming devices may receive the broadcast (e.g., they all receive the same broadcast) and identify which balances apply to that particular device by searching for balances in the broadcast associated with encoded level IDs assigned to that particular gaming device.

In some embodiments, universal progressive gateway 402 may utilize an additional message broker (e.g., RabbitMQ) when transmitting messages associated with a LAP or WAP. In some embodiments, universal progressive gateway 402 may connect directly with WAP controller 412 and/or LAP controller 414 (e.g., without needing LAP proxy service 408 and/or WAP proxy service 410).

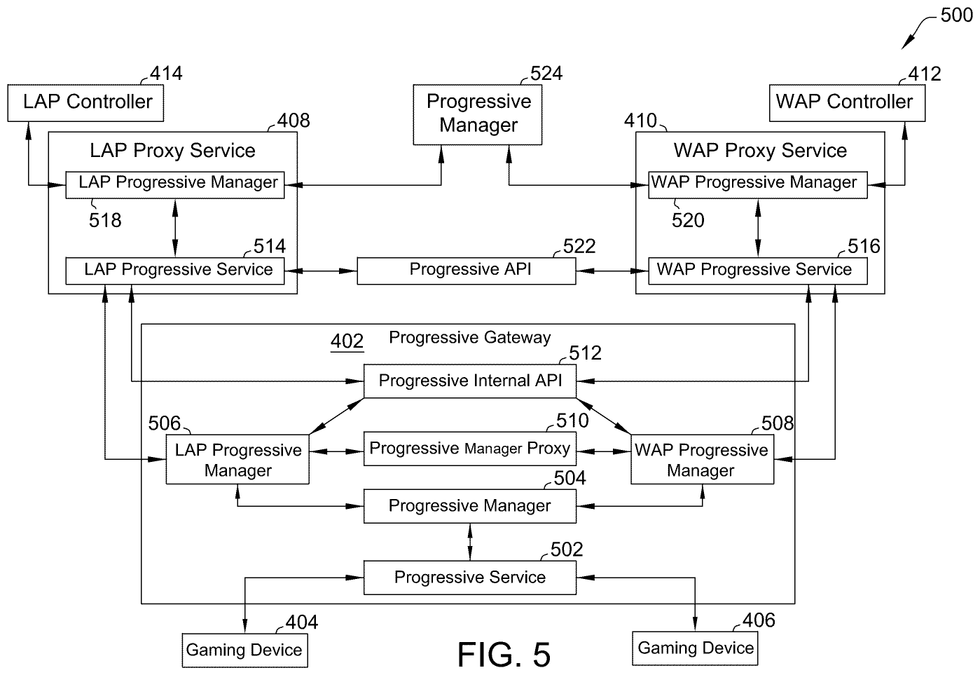

FIG. 5 illustrates another example computer system 500 architecture including universal progressive gateway 402, in accordance with the present disclosure.

As shown in FIG. 5, similar to system 400 of FIG. 4, system 500 generally includes universal progressive gateway 402 in communication with gaming devices 404, 406. Universal progressive gateway 402 is also in communication with LAP proxy service 408 and WAP proxy service 410. LAP proxy service 408 is in communication with LAP controller 414 and WAP proxy service 410 is in communication with WAP controller 412.

Specifically, universal progressive gateway 402 includes a progressive service 502 in communication with a progressive manager 504, which is in communication with a LAP progressive manager 506 and a WAP progressive manager 508. LAP progressive manager 506 and WAP progressive manager 508 are in communication with a progressive manager proxy 510 and a progressive internal API 512 (e.g., that receives progressives used by a game at configuration time). Further, LAP progressive manager 506 is in communication with a LAP progressive service 514 (e.g., of LAP proxy service 408) and WAP progressive manager 508 is in communication with a WAP progressive service 516 (e.g., of WAP proxy service 410).

LAP proxy service 408 includes LAP progressive service 514 in communication with a LAP progressive manager 518. WAP proxy service 410 includes WAP progressive service 516 in communication with a WAP progressive manager 520. LAP progressive service 514 and WAP progressive service 516 are also in communication with a progressive API 522. Further, LAP progressive manager 518 is in communication with a progressive manager 524 and LAP controller 414 and WAP progressive manager 520 is in communication with progressive manager 524 and WAP controller 412.

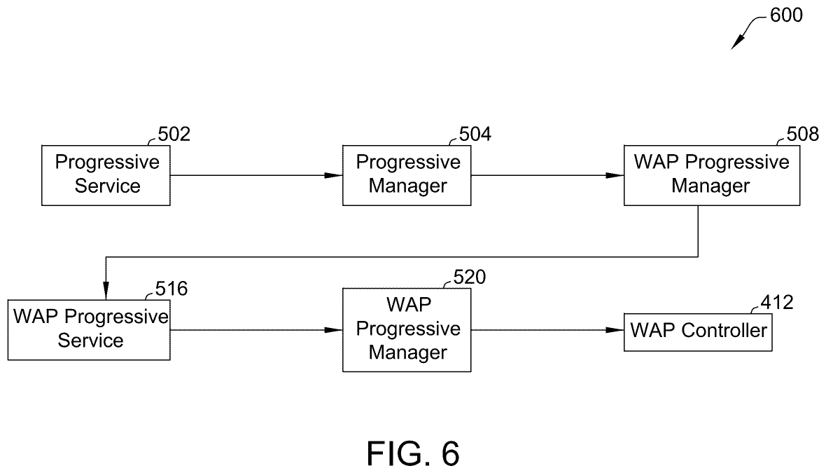

FIG. 6 illustrates an example class diagram 600 for an example computer system including universal progressive gateway 402, in accordance with the present disclosure. For instance, similar to system 500 of FIG. 5, diagram 600 shows progressive service 502 in communication with progressive manager 504, which is in communication with WAP progressive manager 508 (e.g., of universal progressive gateway 402), which is in communication with WAP progressive service 516, which is in communication with WAP progressive manager 520 (e.g., of WAP proxy service 410), which is in communication with WAP controller 412. As an example, the various components shown in FIGS. 4-6 may include various fields, methods, and/or properties associated therewith.

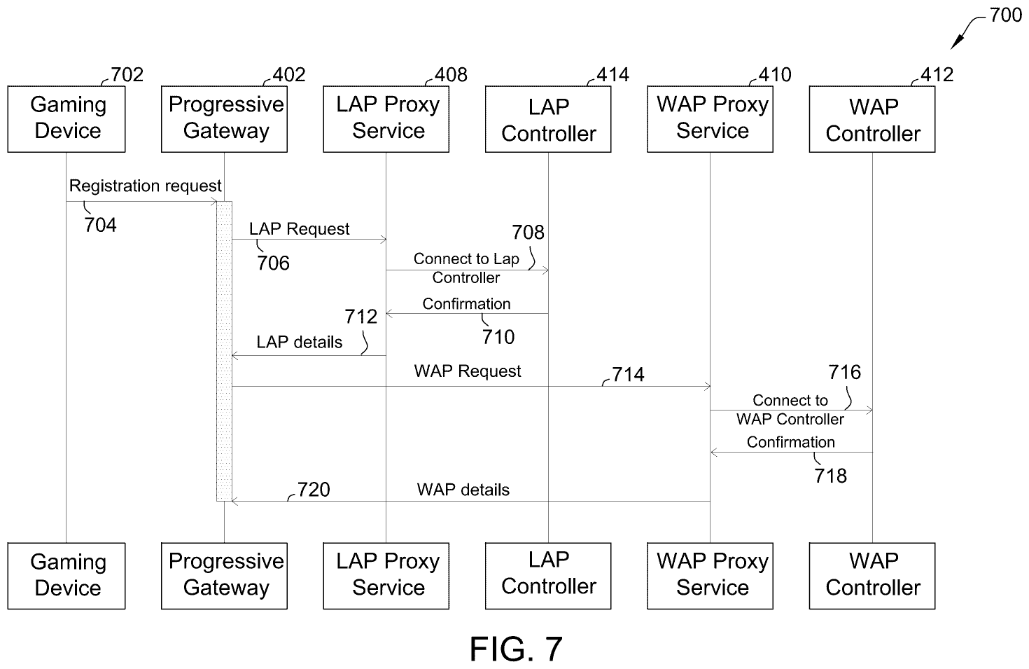

Specific communications between the components shown in FIGS. 4-6 are shown with respect to FIGS. 7-10B.

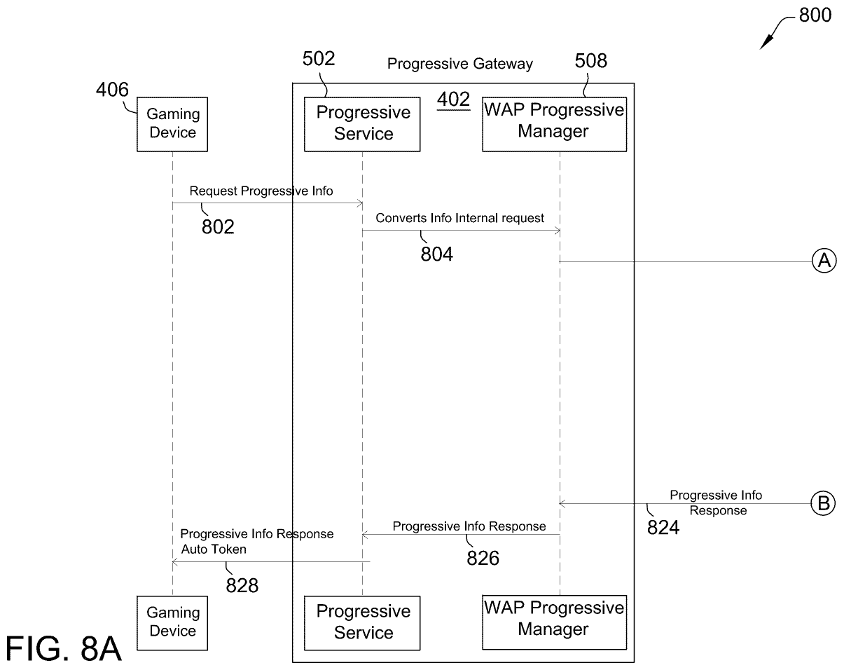

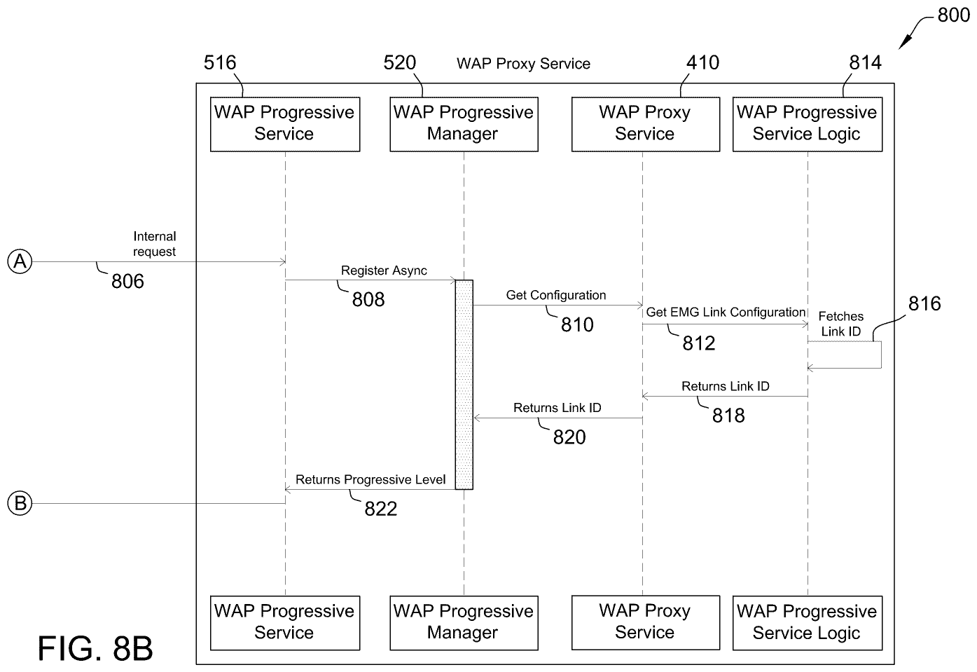

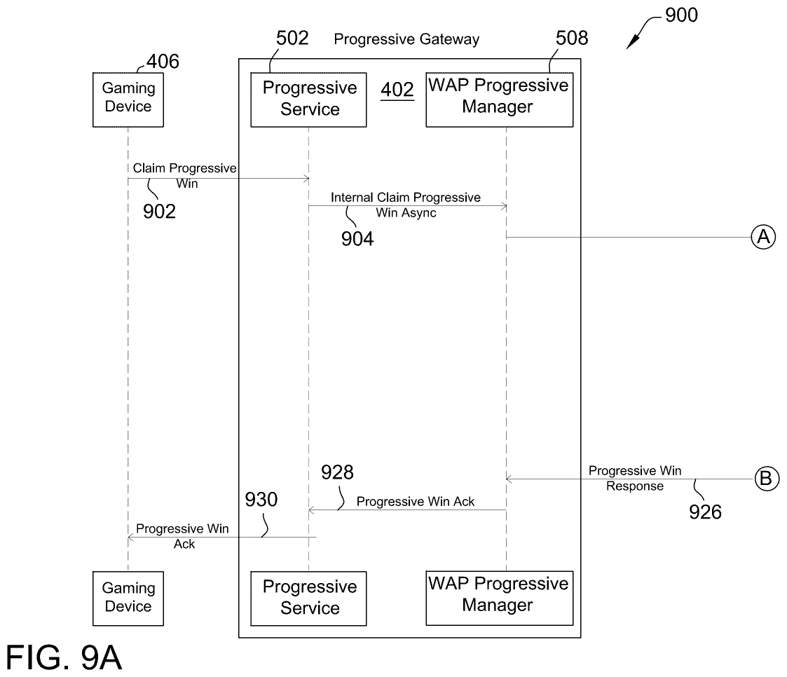

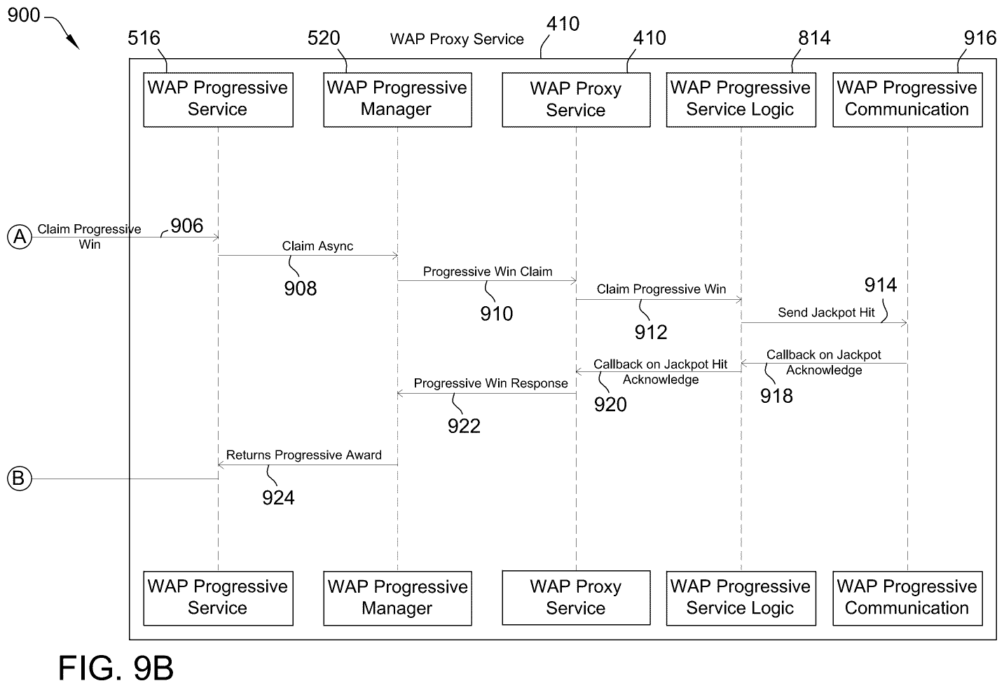

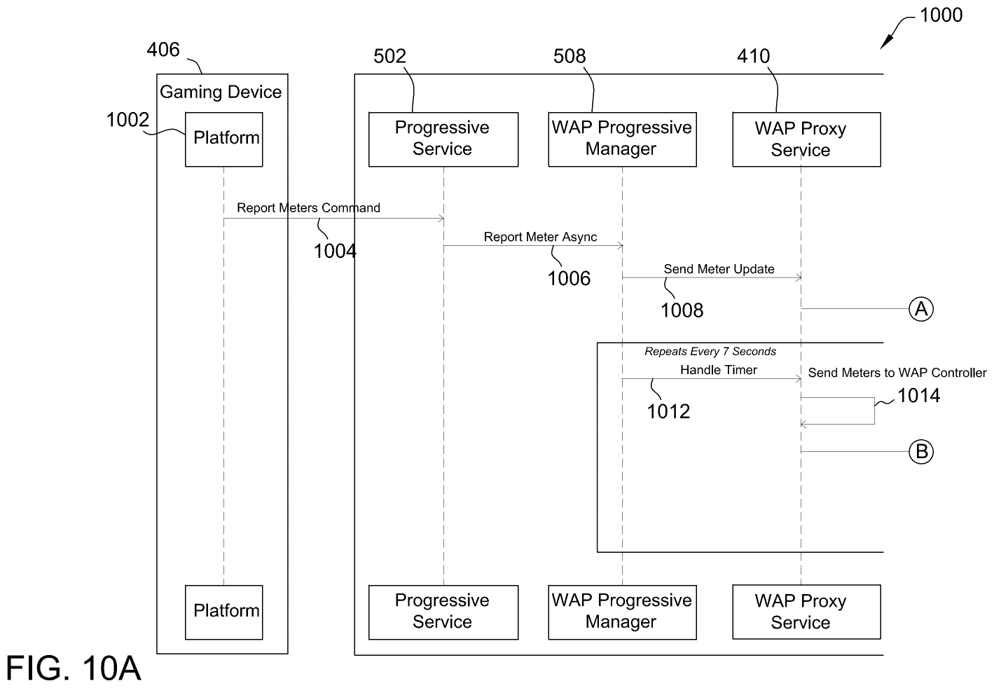

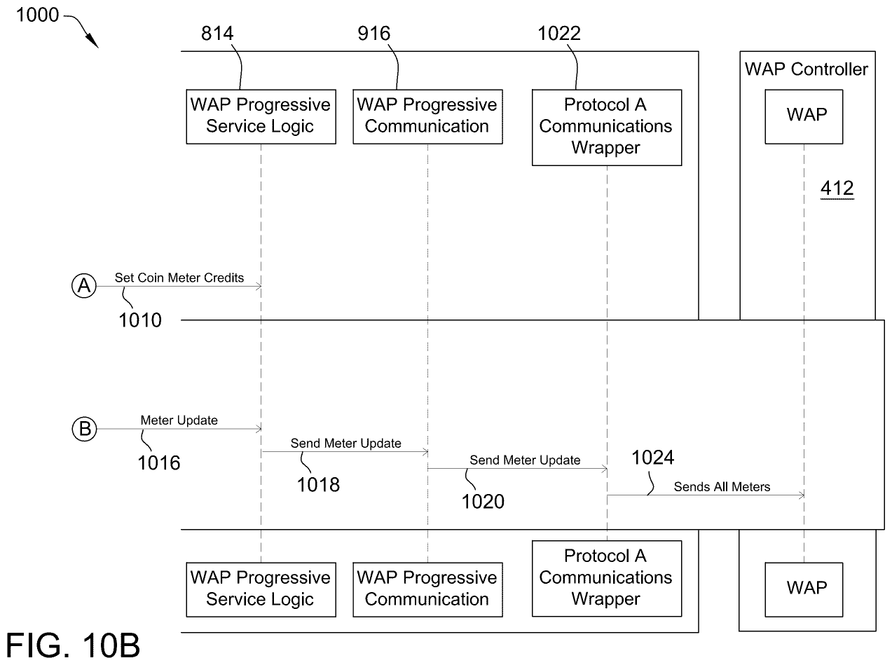

While various examples described herein are described with respect to a WAP and components associated therewith (e.g., WAP controller 412, WAP proxy service 410, etc.) or a LAP and components associated therewith, it should be appreciated that those same and/or similar examples may be implemented with respect to the other of WAP or LAP and/or components associated therewith. For instance, FIGS. 8A-8B illustrate an example registration process for a WAP and components associated therewith but may also be implemented with respect to a LAP and components associated therewith (e.g., and so on with respect to the claim progressive win process shown in FIGS. 9A-9B and the meter update process shown in FIGS. 10A-10B).

FIG. 7 illustrates an example data flow diagram 700 for registering a gaming device 702 (e.g., gaming device 404, 406) in an example computer system including universal progressive gateway 402, in accordance with the present disclosure.

As shown in FIG. 7, gaming device 702 is in communication with universal progressive gateway 402. Universal progressive gateway 402 handles communications with LAP controller 414 (e.g., via LAP proxy service 408) and WAP controller 412 (e.g., via WAP proxy service 410).

As shown in FIG. 7, gaming device 702 transmits a registration request 704 (e.g., including device serial number, etc.) to universal progressive gateway 402 for registering with LAP controller 414 and WAP controller 412 (e.g., because gaming device 702 offers a LAP and a WAP). Universal progressive gateway 402 then proceeds with registering gaming device 702 with LAP controller 414 and/or WAP controller 412. In some embodiments, universal progressive gateway 402 may transmit configuration data for gaming device 702 to both of LAP proxy service 408 and WAP proxy service 410, even if gaming device 702 is only to be registered at one of LAP controller 414 or WAP controller 412 (e.g., gaming device 702 may have been configured for only one of LAP or WAP, for example, by a technician). Whichever of LAP controller 414 or WAP controller 412 does not recognize the configuration data can reject the configuration (e.g., no registration) and whichever of LAP controller 414 or WAP controller 412 does recognize the configuration data can respond accordingly (e.g., with confirmation 710 or confirmation 718).

For instance, universal progressive gateway 402 transmits a LAP request 706 to LAP proxy service 408. LAP proxy service 408 then transmits a connection request 708 to LAP controller 414, which responds to LAP proxy service 408 with a connection confirmation 710. LAP proxy service 408 then provides LAP details 712 (e.g., associated with the LAP) to universal progressive gateway 402.

Further, universal progressive gateway 402 transmits a WAP request 714 to WAP proxy service 410. WAP proxy service 410 then transmits a connection request 716 to WAP controller 412, which responds to WAP proxy service 410 with a connection confirmation 718. WAP proxy service 410 then provides WAP details 720 (e.g., associated with the WAP) to universal progressive gateway 402.

FIGS. 8A and 8B illustrate another example data flow diagram 800 for registering gaming device 406 with WAP controller 412 in an example computer system including universal progressive gateway 402, in accordance with the present disclosure.

As shown in FIGS. 8A and 8B, gaming device 406 sends a request 802 for progressive information (e.g., including a serial number of gaming device 406 and a list of progressive games that may be offered by gaming device 406) to progressive service 502 (e.g., of universal progressive gateway 402) which then transmits a request 804 for request 802 to be converted to an internal request to WAP progressive manager 508. WAP progressive manager 508 converts the progressive information into an internal request 806 and transmits internal request 806 to WAP progressive service 516 (e.g., of WAP proxy service 410).

WAP proxy service 410 then determines a link ID (e.g., associated with the WAP) from stored data (e.g., associated with gaming device 406 and/or the WAP). For instance, WAP progressive service 516 transmits a register async message 808 to WAP progressive manager 520. WAP progressive manager 520 then transmits a get configuration message 810 to WAP proxy service 410 (e.g., other components of WAP proxy service 410) which transmits a get link configuration message 812 (e.g., including a device ID and a link ID associated with gaming device 406) to WAP progressive service logic 814.

WAP progressive service logic 814 determines 816 the link ID (e.g., fetches the link ID from memory based on configurations of WAP controller 412) and returns a link ID message 818 to WAP proxy service 410. WAP proxy service 410 transmits a link ID message 820 to WAP progressive manager 520. WAP progressive manager 520 generates a progressive level object assigned to the link ID (e.g., and/or a progressive level ID) and transmits a progressive level message 822 to WAP progressive service 516.

WAP progressive service 516 transmits a progressive information response message 824 to WAP progressive manager 508 (e.g., including the link ID assigned to gaming device 406, the progressive levels, and the meters to report (e.g., as determined by WAP progressive service 516 such as coin-in, coin-out, progressive win count, and/or main door open)). WAP progressive manager 508 transmits a progressive information response message 826 to progressive service 502.

In this example, the link ID may be the unencoded level ID. Accordingly, universal progressive gateway 402 converts the unencoded level ID to an encoded level ID for gaming device 406 (e.g., associated with the corresponding progressive and a denomination). Progressive service 502 adds an authorization token (e.g., a JWT (JSON Web Token) authorization token) to the progressive information response and transmits a progressive information response message 828 (e.g., including the authorization token, the encoded level ID, and meter information associated with the WAP) to gaming device 406, thereby completing registration of gaming device 406 (e.g., gaming device can utilize the authorization token, the encoded level ID, and/or the meter information when sending future messages to universal progressive gateway 402).

FIGS. 9A and 9B illustrate an example data flow diagram 900 for gaming device 406 claiming a progressive win in an example computer system including universal progressive gateway 402, in accordance with the present disclosure.

Generally, universal progressive gateway 402 routes a claim for the WAP to WAP Proxy Service 410. Through various modules within WAP Proxy Service 410, the jackpot win is acknowledged and an acknowledgement response message is transmitted back to universal progressive gateway 402. Universal progressive gateway 402 then transmits a progressive win acknowledgement back to gaming device 406, completing the process.

As shown in FIGS. 9A and 9B, gaming device 406 transmits a claim 902 (e.g., including an encoded level ID and/or other data) for a progressive win to progressive service 502 (e.g., of universal progressive gateway 402). Progressive service 502 transmits an internal claim 904 (e.g., including decoded level ID based on the received encoded level ID—the decoding of the encoded level ID allows universal progressive gateway to determine to communicate with components associated with a WAP (e.g., instead of components associated with a LAP), in this example) for the progressive win to WAP progressive manager 508. WAP progressive manager 508 transmits a request 906 for the progressive to WAP progressive service 516 which then transmits a claim message 908 to WAP progressive manager 520. WAP progressive manager 520 transmits a progressive win message 910 to WAP proxy service 410 which transmits a claim message 912 for the progressive win to WAP progressive service logic 814. WAP progressive service logic 814 then transmits a jackpot hit message 914 to a WAP progressive communication module 916.

Upon receipt of jackpot hit message 914, WAP progressive communication module 916 acknowledges the jackpot hit (e.g., based on communications/checks with WAP controller 412) and transmits a jackpot acknowledgement message 918 to WAP progressive service logic 814. WAP progressive service logic 814 similarly transmits a jackpot acknowledgement message 920 to WAP proxy service 410 which transmits a progressive win response 922 to WAP progressive manager 520. WAP progressive manager 520 transmits a progressive award message 924 to WAP progressive service 516 (e.g., and updates a jackpot ID). WAP progressive service 516 transmits a progressive win response message 926 to WAP progressive manager 520, which transmits a progressive win acknowledgement message 928 to progressive service 502. Progressive service 502 then transmits a progressive win acknowledgement message 930 back to gaming device 406.

Other gaming devices may not know specifically that gaming device 406 triggered a progressive win. However, after the progressive win, meters associated with the progressive would be reset to a progressive reset value and that reset value would be broadcast out to the other gaming devices (e.g., see FIGS. 10A and 10B).

FIGS. 10A and 10B illustrate an example data flow diagram 1000 for updating progressive meters in an example computer system including universal progressive gateway 402, in accordance with the present disclosure.

Generally, at the end of each game round (e.g., play/spin of a game), gaming device 406 (e.g., a platform 1002 at gaming device 406) sends game data (e.g., coinIn, coinOut, encoded level ID, etc.) to universal progressive gateway 402. Upon receiving the game data, universal progressive gateway 402 converts meters (e.g., in the game data and/or unencodes the encoded level ID) to credits and updates local data structures corresponding to gaming device 406 from which the game data was received.

Then (e.g., at certain intervals, such as every 7 seconds), universal progressive gateway 402 sends local gaming device data structures (e.g., for a plurality of gaming devices) to WAP controller 412 in terms of credits. The credits are then converted into dollars on WAP controller 412 according to a set denomination associated with the credits. WAP controller 412 compares a previous coinIn value with the one received from universal progressive gateway 402, and adds the difference to the progressive (e.g., a stored balance associated with the WAP) based on a contribution percentage set in WAP controller 412. The updated progressives are then transmitted back to universal progressive gateway 402 (e.g., at certain intervals, such as every 2 seconds) and universal progressive gateway 402 informs the gaming devices of the updated progressives.

Specifically, platform 1002 of gaming device 406 transmits a report meters message 1004 to progressive service 502 (e.g., all meters from gaming device 406 are reported after each game round - including coinIn, coinOut, etc.). Progressive service 502 then transmits a report meter async message 1006 to WAP progressive manager 508 which then transmits a send meter update message 1008 to WAP proxy service 410. WAP proxy service 410 then transmits a set coin meter credits message 1010 to WAP progressive service logic 814, which updates local data structures at WAP proxy service 410 corresponding to gaming device 406.

Further, a process may repeat (e.g., every 7 seconds) to send local gaming device data structures (e.g., associated with all or a portion of gaming devices in communication with universal progressive gateway 402) to WAP controller 412. Specifically, progressive service 502 transmits a handle timer message 1012 to WAP proxy service 410. WAP proxy service 410 then begins a send meters to WAP controller 412 process 1014 and transmits a meter update message 1016 to WAP progressive service logic 814 (e.g., WAP progressive service logic 814 may receive meter update messages associated with a plurality of gaming devices and then send local data structures corresponding to each of the plurality of gaming devices to WAP progressive communication module 916 (e.g., based upon current gaming device meter data)). Send meter update messages 1018, 1020 are then transmitted to WAP progressive communication module 916 and a protocol A communications wrapper 1022 respectively. Protocol A communications wrapper 1022 then transmits a message 1024 with all meters to WAP controller 412.

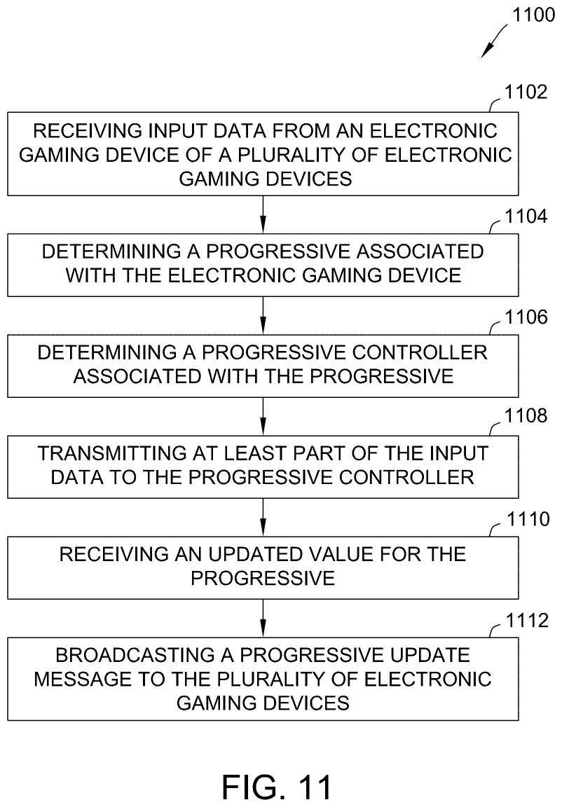

FIG. 11 illustrates an example method 1100 for managing electronic communications in electronic gaming, in accordance with the present disclosure.

In the example embodiment, method 1100 includes receiving 1102 input data from an electronic gaming device of a plurality of electronic gaming devices wherein the input data includes an input amount associated with an electronic game at the electronic gaming device and a device identifier (ID) (e.g., an encoded level ID) associated with the electronic gaming device. Method 1100 also includes, based on the device ID, determining 1104 a progressive associated with the electronic gaming device from a plurality of progressives wherein the progressive is associated with a progressive ID (e.g., an unencoded level ID based on the encoded level ID) and, based on the progressive ID, determining 1106 a progressive controller associated with the progressive from a plurality of progressive controllers.

Method 1100 further includes transmitting 1108 at least part of the input data to the progressive controller, receiving 1110 an updated value for the progressive from the progressive controller, and broadcasting 1112 a progressive update message to the plurality of electronic gaming devices wherein the progressive update message includes the updated value and the device ID and wherein the electronic gaming device is configured to update a value of the progressive at the electronic gaming device to the updated value based upon receiving the broadcast and identifying that the updated value is associated with the device ID.

In some embodiments of method 1100, the device ID is an encoded ID associated with the electronic gaming device, method 1100 further includes determining the encoded ID based at least in part upon the progressive (e.g., and a denomination) and transmitting the encoded ID to the electronic gaming device.

In some embodiments, method 1100 includes receiving a first progressive claim message associated with a claim for the progressive from the electronic gaming device, transmitting a second progressive claim message based at least in part upon the first progressive claim message to the progressive controller, receiving a first acknowledgement message associated with acknowledging the claim for the progressive from the progressive controller, and transmitting a second acknowledgement message associated with the first acknowledgement message to the electronic gaming device.

In some embodiments, method 1100 includes, based at least in part upon the claim for the progressive, broadcasting a second progressive update message including a reset value for the progressive and the device ID.

It should be appreciated that various additional and/or alternative embodiments are envisioned with respect to the present disclosure. For instance, universal progressive gateway 402 may also handle disabling certain gaming devices. Example trigger conditions for disabling a gaming device (e.g., detected by universal progressive gateway 402 or another device in communication with universal progressive gateway 402) include a negative coin-in reported from a gaming device, a negative coin-out reported from a gaming device, an unregistered gaming device request (e.g., if a gaming device requests registration, see FIGS. 8A-8B, but the system has not yet associated the gaming device serial number with an ID (e.g., a device ID) in memory, the gaming device will be disabled), a device ID being removed from WAP controller 412, removal of a link from WAP controller 412, and/or a link to WAP controller 412 (e.g., from universal progressive gateway 402) being down.

In some embodiments, set up timers and handlers are provided. A series of timers and exception handling may attempt to establish a plan of action for disabling gaming devices when certain critical moments are determined to have happened as the result of various types of connections. At the moment protocol A communications wrapper 1022 or WAP progressive communication module 916 is able to reconnect to WAP controller 412, the WAP progressive service logic 814 may be notified, reconnect logic resumes, and effectively all processes from device registration to other operations described herein are resumed.

In some embodiments, if a catastrophic failure is detected then progressive updates will be stopped after a period of time has elapsed. For instance, a restart timer may be started and after 60 seconds a connection attempt may be made. If a catastrophic failure is detected, progressive updates will be stopped until a connection is made to WAP controller 412.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory with instructions stored thereon; and
at least one processor in communication with the at least one memory, wherein the instructions, when executed by the at least one processor, cause the at least one processor to:
receive input data from an electronic gaming device of a plurality of electronic gaming devices, wherein the input data comprises an input amount associated with an electronic game at the electronic gaming device and a device identifier (ID) associated with the electronic gaming device;
based on the device ID, determine a progressive associated with the electronic gaming device from a plurality of progressives, wherein the progressive is associated with a progressive ID;
based on the progressive ID, determine a progressive controller associated with the progressive from a plurality of progressive controllers;
transmit at least part of the input data to the progressive controller;
receive an updated value for the progressive from the progressive controller; and
broadcast a progressive update message to the plurality of electronic gaming devices, wherein the progressive update message includes the updated value and the device ID, and wherein the electronic gaming device is configured to update a value of the progressive at the electronic gaming device to the updated value based upon receiving the broadcast and identifying that the updated value is associated with the device ID.

2. The electronic gaming system of claim 1, wherein the plurality of progressives includes at least one local area progressive (LAP) and at least one wide area progressive (WAP).

3. The electronic gaming system of claim 1, wherein the device ID is an encoded ID associated with the electronic gaming device.

4. The electronic gaming system of claim 3, wherein the instructions further cause the at least one processor to:
determine the encoded ID based at least in part upon the progressive; and
transmit the encoded ID to the electronic gaming device.

5. The electronic gaming device of claim 4, wherein the instructions further cause the at least one processor to determine and transmit the encoded ID as part of a registration process for the electronic gaming device with the electronic gaming system.

6. The electronic gaming system of claim 3, wherein the instructions further cause the at least one processor to decode the encoded ID to at least one of determine the progressive or determine the progressive controller.

7. The electronic gaming system of claim 1, wherein the instructions further cause the at least one processor to:
receive a first progressive claim message associated with a claim for the progressive from the electronic gaming device;
transmit a second progressive claim message based at least in part upon the first progressive claim message to the progressive controller;
receive a first acknowledgement message associated with acknowledging the claim for the progressive from the progressive controller; and
transmit a second acknowledgement message associated with the first acknowledgement message to the electronic gaming device.

8. The electronic gaming system of claim 7, wherein the instructions further cause the at least one processor to, based at least in part upon the claim for the progressive, broadcast a second progressive update message including a reset value for the progressive and the device ID.

9. At least one non-transitory computer-readable storage medium with instructions stored thereon that, in response to execution by at least one processor, cause the at least one processor to:
receive input data from an electronic gaming device of a plurality of electronic gaming devices, wherein the input data comprises an input amount associated with an electronic game at the electronic gaming device and a device identifier (ID) associated with the electronic gaming device;
based on the device ID, determine a progressive associated with the electronic gaming device from a plurality of progressives, wherein the progressive is associated with a progressive ID;
based on the progressive ID, determine a progressive controller associated with the progressive from a plurality of progressive controllers;
transmit at least part of the input data to the progressive controller;
receive an updated value for the progressive from the progressive controller; and
broadcast a progressive update message to the plurality of electronic gaming devices, wherein the progressive update message includes the updated value and the device ID, and wherein the electronic gaming device is configured to update a value of the progressive at the electronic gaming device to the updated value based upon receiving the broadcast and identifying that the updated value is associated with the device ID.

10. The at least one non-transitory computer-readable storage medium of claim 9, wherein the plurality of progressives includes at least one local area progressive (LAP) and at least one wide area progressive (WAP).

11. The at least one non-transitory computer-readable storage medium of claim 9, wherein the device ID is an encoded ID associated with the electronic gaming device.

12. The at least one non-transitory computer-readable storage medium of claim 11, wherein the instructions further cause the at least one processor to:
determine the encoded ID based at least in part upon the progressive; and
transmit the encoded ID to the electronic gaming device.

13. The at least one non-transitory computer-readable storage medium of claim 12, wherein the instructions further cause the at least one processor to determine and transmit the encoded ID as part of a registration process for the electronic gaming device.

14. The at least one non-transitory computer-readable storage medium of claim 11, wherein the instructions further cause the at least one processor to decode the encoded ID to at least one of determine the progressive or determine the progressive controller.

15. The at least one non-transitory computer-readable storage medium of claim 9, wherein the instructions further cause the at least one processor to:
receive a first progressive claim message associated with a claim for the progressive from the electronic gaming device;
transmit a second progressive claim message based at least in part upon the first progressive claim message to the progressive controller;
receive a first acknowledgement message associated with acknowledging the claim for the progressive from the progressive controller; and
transmit a second acknowledgement message associated with the first acknowledgement message to the electronic gaming device.

16. The at least one non-transitory computer-readable storage medium of claim 9, wherein the instructions further cause the at least one processor to, based at least in part upon the claim for the progressive, broadcast a second progressive update message including a reset value for the progressive and the device ID.

17. A method for managing electronic communications in electronic gaming, the method implemented by at least one processor in communication with at least one memory, the method comprising:
receiving input data from an electronic gaming device of a plurality of electronic gaming devices, wherein the input data comprises an input amount associated with an electronic game at the electronic gaming device and a device identifier (ID) associated with the electronic gaming device;
based on the device ID, determining a progressive associated with the electronic gaming device from a plurality of progressives, wherein the progressive is associated with a progressive ID;
based on the progressive ID, determining a progressive controller associated with the progressive from a plurality of progressive controllers;
transmitting at least part of the input data to the progressive controller;
receiving an updated value for the progressive from the progressive controller; and
broadcasting a progressive update message to the plurality of electronic gaming devices, wherein the progressive update message includes the updated value and the device ID, and wherein the electronic gaming device is configured to update a value of the progressive at the electronic gaming device to the updated value based upon receiving the broadcast and identifying that the updated value is associated with the device ID.

18. The method of claim 17, wherein the device ID is an encoded ID associated with the electronic gaming device, the method further comprising:
determining the encoded ID based at least in part upon the progressive; and
transmitting the encoded ID to the electronic gaming device.

19. The method of claim 17, further comprising:
receiving a first progressive claim message associated with a claim for the progressive from the electronic gaming device;
transmitting a second progressive claim message based at least in part upon the first progressive claim message to the progressive controller;
receiving a first acknowledgement message associated with acknowledging the claim for the progressive from the progressive controller; and
transmitting a second acknowledgement message associated with the first acknowledgement message to the electronic gaming device.

20. The method of claim 17, further comprising, based at least in part upon the claim for the progressive, broadcasting a second progressive update message including a reset value for the progressive and the device ID.
